(19) United States
(12) Patent Application Publication
(10) Pub. No.: US 2010/0024974 A1
(43) Pub. Date: Feb. 4, 2010

(54) BONDING METHOD AND BONDING APPARATUS

(76) Inventor: Haruka Narita, Kanagawa (JP)

Correspondence Address: SNELL & WILMER LLP (OC), 600 ANTON BOULEVARD, SUITE 1400, COSTA MESA, CA, 92626, US

(21) Appl. No.: 12/443,458

(22) PCT Filed: Sep. 20, 2007
(86) PCT No.: PCT/JP2007/001023

§ 371 Date: Jul. 9, 2009

(30) Foreign Application Priority Data
Sep. 28, 2006 (JP) 2006-263951

(51) Int. Cl. B29C 65/14; B29C 65/52

(52) U.S. Cl. 156/275.5; 156/379.8

(57) ABSTRACT

A bonding method and a bonding apparatus whereby the uniformity of an adhesive layer during application is ensured, variation of the adhesive layer during manufacture can be suppressed and the occurrence of air bubbles can be reduced. The bonding apparatus includes: a first spin coating device 1 for applying an adhesive B1 onto one surface of a first substrate P1; a second spin coating device for applying an adhesive B2 onto one surface of a second substrate P2, more thinly than the adhesive B1 on the first substrate; a pre-irradiation unit 4 for provisionally curing the adhesive B1 on the first substrate P1; a bonding unit 5 for bonding together the surface of the first substrate P1 to which the adhesive B1 has been applied and the surface of the second substrate P2 to which the adhesive B2 has been applied; and a post-irradiation unit 6 which cures the adhesive B1 and B2 between the first substrate P1 and the second substrate P2.

### TECHNICAL FIELD

The present invention relates to a bonding method and bonding apparatus which improve the application of an adhesive onto a substrate before bonding, in order to manufacture a recording medium in which a pair of substrates are bonded together by means of an adhesive.

### BACKGROUND ART

Currently, in the field of optically readable recording media such as optical disks or magneto-optical disks, disks having a wide variety of different specifications are used, for instance, there are read-only media and media which enable rewriting of the recorded information. An optical disk such as a DVD, for example, is basically manufactured by providing information recording regions on one side or both sides of two substrates, and bonding the substrates together by means of an adhesive. The adhesive layer for bonding the substrates together is required to have an extremely accurate thickness in order that information can be read and written accurately by laser.

One example of a procedure for manufacturing a bonded disk of this kind is described now with reference to FIG. 6. Firstly, two polycarbonate substrates P are previously formed by extrusion molding, and a metal film for reflecting laser light (recording film) is formed by sputtering in a sputtering chamber. As shown in FIG. 6A, an ultraviolet-curable adhesive is applied to the bonding surfaces of two substrates P, and the adhesive is caused to spread by spin coating. Spin coating is a process in which an adhesive is applied dripwise (dropt) by an application device K about the perimeter of the center of a substrate P and the substrate P is spun at high speed, whereby a thin film of adhesive (adhesive layer R) is formed on the substrate P, and surplus adhesive is scattered.

As shown in FIG. 6B, one of the pair of substrates P on which an adhesive layer R has been formed in this way is held by a chuck E of a center pin G and the other of the substrates is mounted on the mounting surface F of a turntable or susceptor, in such a manner that the respective adhesive layers R are facing each other in parallel, whereupon the substrates are introduced into the lower part of a vacuum chamber C. Thereupon, as shown in FIG. 6C, a vacuum chamber S is formed by lowering and sealing the vacuum chamber C, and the pressure of the periphery of the substrates P is reduced from atmospheric pressure to a vacuum by evacuating air from the vacuum chamber S by means of an air evacuation device.

The chuck E holding one substrate P is closed inside the space that has been reduced to vacuum pressure, and the substrates P are lowered, in addition to which a pressing section T is lowered and caused to apply pressure by a drive source, such as a cylinder, thereby bonding the one substrate P to the other substrate P. A vacuum pressure is created during bonding in order to eliminate as far as possible any gas molecules present between the surfaces that are to be bonded.

Thereupon, as shown in FIG. 6D, the peripheral atmosphere of the substrates P that have been bonded together is either returned to atmospheric pressure or raised to a pressure higher than atmospheric pressure and then returned to atmospheric pressure, by introducing air. By returning the substrates to atmospheric pressure in this way, any air bubbles remaining in the adhesive layers R are caused to contract gradually to the pressure difference with respect to the vacuum. After the substrates P have been left at atmospheric pressure for several seconds to several tens of seconds until the air bubbles have been contracted sufficiently, then as shown in FIG. 6E, the adhesive layer R is cured by irradiating ultraviolet light onto the whole of the substrates by a light source U. By this means, the two substrates P are bonded strongly together, thereby completing a disk.

In a disk which is manufactured by bonding together substrates onto which an adhesive has been applied as described above, when laser light used for reading and writing information is irradiated onto the disk, then it is necessary for the adherence of dirt and the occurrence of air bubbles to be reduced as far as possible in such a manner that a stable spot is formed. In order to achieve this, in the prior art, bonding is carried out in a vacuum and pressure is applied after bonding. One technique for applying pressure in this way is to use atmospheric pressure and expose the disk to an air atmosphere for a prescribed period of time (air resting) (see Patent Reference 1).

Patent Reference 1: Japanese Patent Application Publication No. 2006-48855.

However, in a disk of this kind, in order to form a stable laser spot, it is also necessary for the disk to be a flat disk which is free of warping or distortion. Consequently, in a disk of this kind, it is desirable that the film thickness of the adhesive layer during bonding should be as uniform as possible. For example, it is known that the variation (fluctuation) in the circumferential direction (in-circumference variation) of the film thickness of an adhesive layer applied by spin coating becomes greater from the inner circumference of the disk toward the outer circumference.

With increase in the recording density in recent years, as in the case of HD (High Definition DVD) and BD (Blu-ray Disc), the uniformity of the adhesive layer required in the final disk has become subject to extremely strict requirements. For example, in a conventional DVD, the range of variation is approximately 30 μm, but in HD or BD disks, greater accuracy of approximately 10 μm is necessary. Furthermore, with this increase in recording density, in order to prevent reading errors, it has become necessary to reduce yet further the size and quantity of adhering dirt and air bubbles.

However, as described in the abovementioned Patent Document 1 if the substrates are left in an air atmosphere after bonding in order to reduce air bubbles, then the in-circumference variation of the adhesive layer increases. This is thought to be because the time from the deposition of the adhesive until its curing becomes long and hence there is increased chance of the adhesive flowing during the curing process. For example, FIG. 7 shows individual and average measurement results for the rate of in-circumference variation in a case where the substrates are not left to rest after bonding together, and in a case where the substrates are left for 20 seconds after bonding together. As shown in FIG. 7, it can be seen that when the substrates are left to rest, there is overall deterioration in the in-circumference variation and there is significant variation in the outer circumference portion.

### DISCLOSURE OF THE INVENTION

The present invention was devised in order to resolve the aforementioned problems of the prior art, an object thereof being to provide a bonding method and a bonding apparatus whereby uniformity of the adhesive layer during application can be ensured, while suppressing variation in the adhesive layer during manufacture.

In order to achieve the object described above, the present invention is a bonding method for bonding a first substrate and a second substrate by means of an adhesive which undergoes curing by irradiation of electromagnetic radiation, characterized in comprising: applying the adhesive, at respectively different thicknesses, to one surface of the first substrate and one surface of the second substrate; irradiating electromagnetic radiation onto the thicker of the adhesive applied to the first substrate and the adhesive applied to the second substrate; bonding together the surface of the first substrate to which the adhesive has been applied and the surface of the second substrate to which the adhesive has been applied; and irradiating electromagnetic radiation onto the adhesive between the first substrate and the second substrate.

Another mode of the present invention is a bonding apparatus for bonding together a first substrate and a second substrate by means of an adhesive which undergoes curing by irradiation of electromagnetic radiation, characterized in comprising: at least one application unit for applying the adhesive, at respectively different thicknesses, to one surface of the first substrate and one surface of the second substrate; a pre-irradiation unit for irradiating electromagnetic radiation onto the thicker of the adhesive applied to the first substrate and the adhesive applied to the second substrate; a bonding unit for bonding together the surface of the first substrate to which the adhesive has been applied and the surface of the second substrate to which the adhesive has been applied; and a post-irradiation unit for irradiating electromagnetic radiation onto the adhesive between the first substrate and the second substrate.

In the inventions described above, since the thicknesses of the adhesive to be applied to the substrates are made different before bonding together the first substrate and the second substrate and electromagnetic radiation is irradiated onto the thicker of the adhesives, then the thicker region is provisionally cured and in-circumference variation is suppressed, in addition to which the occurrence of air bubbles after bonding can be reduced.

Another mode of the present invention is a bonding method for bonding a first substrate and a second substrate by means of an adhesive which undergoes curing by irradiation of electromagnetic radiation, characterized in comprising: applying the adhesive, at respectively different thicknesses, to one surface of the first substrate and one surface of the second substrate; irradiating electromagnetic radiation onto both the adhesive applied to the first substrate and the adhesive applied to the second substrate; bonding together the surface of the first substrate to which the adhesive has been applied and the surface of the second substrate to which the adhesive has been applied; and irradiating electromagnetic radiation onto the adhesive between the first substrate and the second substrate.

A further mode of the present invention is a bonding apparatus for bonding together a first substrate and a second substrate by means of an adhesive which undergoes curing by irradiation of electromagnetic radiation, characterized in comprising: at least one application unit for applying the adhesive at respectively different thicknesses to one surface of the first substrate and one surface of the second substrate; a pre-irradiation unit for irradiating electromagnetic radiation onto both the adhesive applied to the first substrate and the adhesive applied to the second substrate; a bonding unit for bonding together the surface of the first substrate to which the adhesive has been applied and the surface of the second substrate to which the adhesive has been applied; and a post-irradiation unit for irradiating electromagnetic radiation onto the adhesive between the first substrate and the second substrate.

In modes such as those described above, since electromagnetic radiation is irradiated onto both of the adhesives before bonding together the first substrate and the second substrate, it is possible to carry out bonding in a state where the flowing movement of both adhesives has been controlled, and therefore it is possible to suppress in-circumference variation in the adhesive layer, as well as being able to reduce the occurrence of air bubbles after bonding.

In a further mode of the invention, the application unit has at least one spin coating device for spreading the adhesive by causing the first substrate and the second substrate to rotate, control means being further provided for controlling the spin coating device such that conditions of rotation are respectively different for the first substrate and the second substrate is also provided.

In modes such as those described above, it is possible to control the application thickness of the adhesive by changing the conditions of rotation, such as the rotational speed.

In a further mode of the invention, the application unit comprises at least one spin coating device for spreading the adhesive by rotating the first substrate and the second substrate, and control means being further provided for controlling the spin coating device such that the number of spreading operations is respectively different for the first substrate and the second substrate is also provided.

In modes such as those described above, the application thickness of the adhesive is controlled on the basis of the number of superimposed application operations performed, by changing the number of adhesive spreading operations, and therefore uniformity can be ensured readily even if the adhesive is formed thickly.

As described above, according to the present invention, it is possible to provide a bonding method and a bonding apparatus whereby the uniformity of an adhesive layer during application can be ensured, variation in the adhesive layer during manufacture can be suppressed, and the occurrence of air bubbles can be reduced.

### BRIEF DESCRIPTION OF THE DRAWINGS

FIG. 1 is an explanatory diagram showing the composition of one embodiment of a bonding apparatus according to the present invention;

FIG. 2 is a simplified vertical cross-section showing a first spin coating device according to the embodiment in FIG. 1;

FIG. 3 is a flowchart showing the processing sequence of the embodiment in FIG. 1;

FIG. 4 is an explanatory diagram showing the level of occurrence of air bubbles in disks having different film thickness ratios which are manufactured in accordance with an embodiment of the present invention;

FIG. 5 is an explanatory diagram showing one embodiment of a case where two pre-irradiation units are disposed in the bonding apparatus according to the present invention;

FIGS. 6A to 6E are explanatory diagrams showing a substrate bonding procedure according to the prior art, in which FIG. 6A shows a step of spreading adhesive, FIG. 6B shows a step of introducing into a vacuum chamber, FIG. 6C shows a bonding step, FIG. 6D shows an air resting step, and FIG. 6E shows an adhesive curing step; and

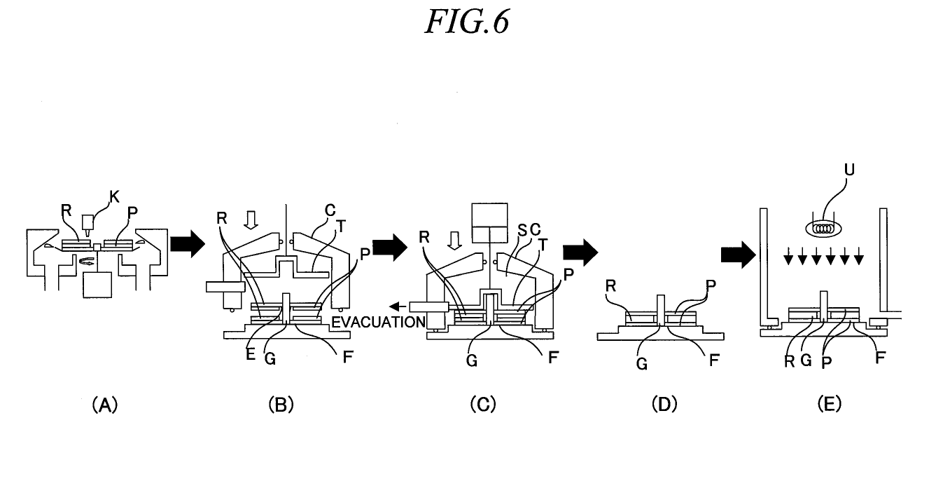

FIG. 7 is an explanatory diagram showing the in-circumference distribution of the adhesive layer thickness of a disk manufactured in accordance with prior art technology.

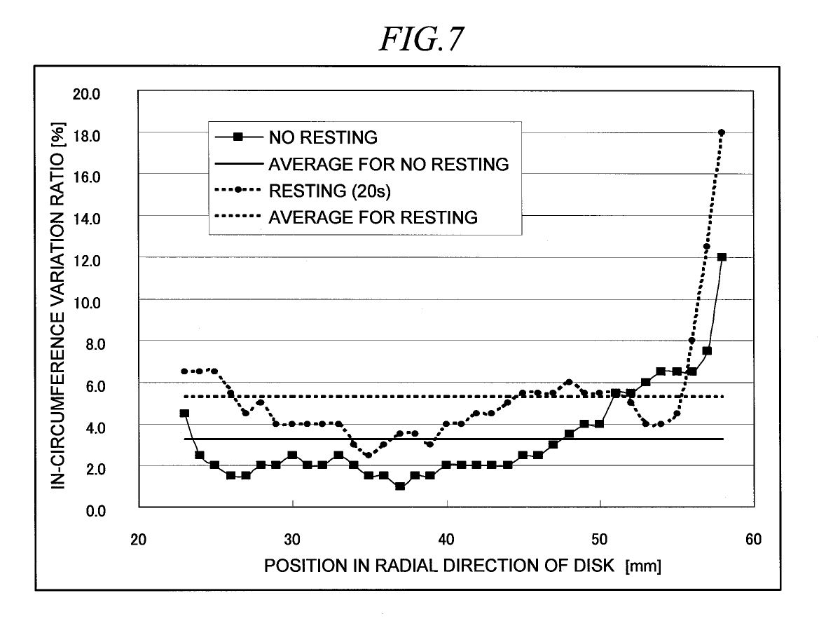

### BEST MODE FOR CARRYING OUT THE INVENTION

Next, a preferred embodiment of the present invention (hereinafter, called “embodiment”) will be described with reference to the drawings. In the present embodiment, adhesive is applied to different thicknesses on a pair of substrates, and the adhesive is provisionally cured, whereupon the substrates are bonded together, and by this means in-circumference variation of the adhesive is suppressed.

### Composition of the Embodiment

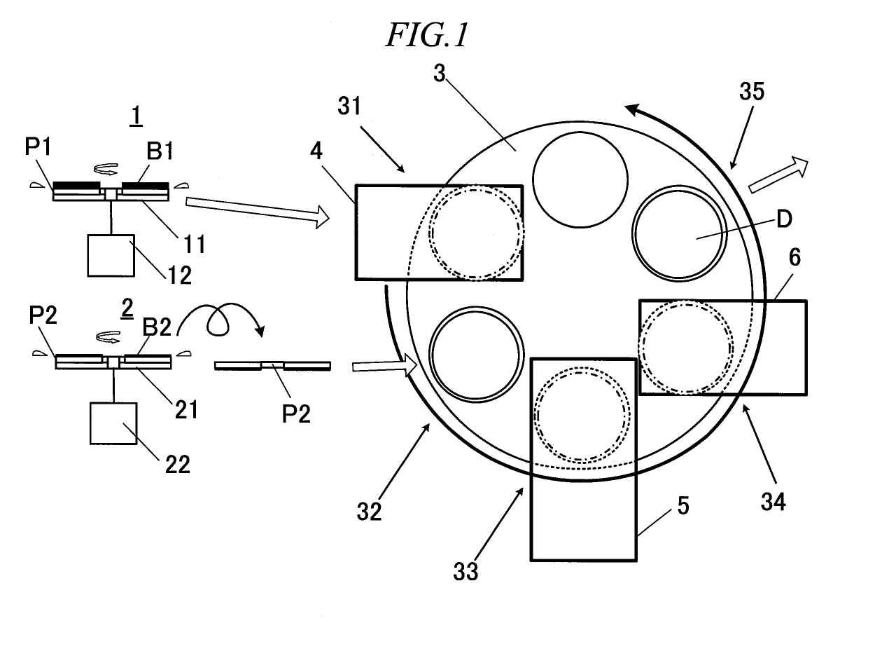

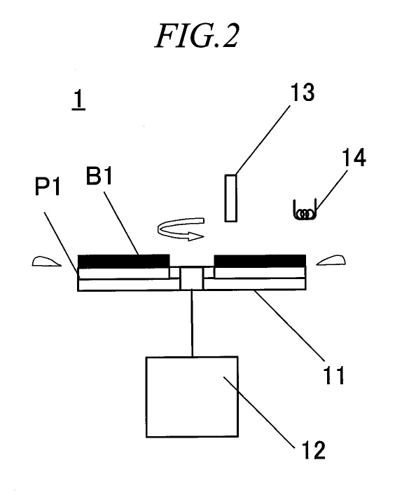

Firstly, the composition of the bonding apparatus according to the present embodiment (hereinafter, called the “present apparatus”) will be described with reference to FIG. 1 and FIG. 2. The present apparatus constitutes a portion of a disk manufacturing apparatus, and the substrate molding device and metal film forming device disposed to the upstream process side of the present apparatus and the mechanisms for transferring the substrates between the respective devices use commonly known technology and therefore description thereof is omitted here.

The present apparatus comprises a first spin coating device 1, a second spin coating device 2, a pre-irradiation unit 4 constituted by a turntable 3, a bonding unit 5, a post-irradiation unit 6, and the like. The first spin coating device 1 is a device which coats an ultraviolet-curable adhesive B1 by spin coating onto one substrate P1 that is to be bonded. This first spin coating device 1 comprises a turntable 11 on which a substrate P1 is mounted and a drive source 12 which causes the turntable 11 to rotate, and it serves to cause adhesive B1 that has been dripped onto the substrate by an adhesive supply unit (not illustrated) to spread due to the rotation of the substrate P1.

Furthermore, as shown in FIG. 2, the first spin coating device 1 comprises an irradiation device 13 which irradiates ultraviolet light (UV) onto the adhesive B1 on a substrate P1, and a heating device 14 which applies heat. The irradiation device 13 is a device which irradiates ultraviolet light in the form of spots about the periphery of the central hole of the substrate P1, and is composed in such a manner that ultraviolet light from a light source is guided along an optical fiber. It may also be composed in such a manner that the irradiation intensity can be adjusted by using ultraviolet light LEDs for the light source. The heating device 14 is a device for heating the substrate P1 in the vicinity of its outer circumference. The heating device 14 may employ an infrared (IR) irradiation unit or a heater, for instance.

The second spin coating device 2 is a device which coats an ultraviolet-curable adhesive by spin coating onto another substrate P2 that is to be bonded, as shown in FIG. 1. This second spin coating device 2 comprises a turntable 21 on which a substrate P2 is mounted and a drive source 22 which causes the turntable 21 to rotate, and it serves to cause adhesive B2 that has been dripped onto the substrate by an adhesive supply unit (not illustrated) to spread due to the rotation of the substrate P2.

The turntable 3 has a first introduction position 31, corresponding to the pre-irradiation unit 4, where the substrate P1 is introduced, a second introduction position 32 where the substrate P2 is introduced after being inverted by an inverting device (not illustrated) in such a manner that the bonding surfaces are facing each other, a bonding position 33 which corresponds to the bonding unit 5, an ultraviolet light irradiation position 34 which corresponds to the post-irradiation unit 6, and an output position 35 where the completed disk D is output to the next stage. This turntable 3 is composed so as to turn intermittently in accordance with the respective positions described above, by means of a drive mechanism (not illustrated).

The pre-irradiation unit 4 is a device which performs provisional curing by irradiating ultraviolet light by a UV irradiation device in an air atmosphere onto the adhesive B1 which has been applied to the substrate P1. Here, “in an air atmosphere” means in an environment which inhibits curing, for example, an oxygen-containing gas atmosphere. In general, it is easiest to use normal air, but any environment which contains oxygen or which inhibits curing would be suitable.

The bonding unit 5 is a device which bonds together the substrates P1 and P2 in a vacuum. The bonding unit 5 has a vacuum chamber which is operated by an elevator mechanism, a vacuum source which reduces the interior of the vacuum chamber to a vacuum, and a pressing unit which is operated by an elevator mechanism and applies pressure to the substrates P1 and P2, but since this involves commonly known technology, it is not described further here.

The post-irradiation unit 6 is a device which irradiates ultraviolet light in a vacuum onto the bonded substrates P1 and P2, by means of the UV irradiation device, and thereby fully cures the adhesives B1 and B2 between the substrates P1 and P2. The post-irradiation unit 6 also comprises a vacuum chamber which is operated by an elevator mechanism and a vacuum source which reduces the interior of the vacuum chamber to a vacuum pressure, and the like, but since this involves commonly known technology, it is not described further here.

Irradiation is carried out in a vacuum in order to remove any factors which may inhibit curing, such as the presence of oxygen, or the like, but it is not absolutely necessary to carry out irradiation in an environment which is free of oxygen. This is because the adhesive bonding surfaces of the substrates P1 and P2 after they have been bonded together form a substantially unified body, which is cured regardless of the atmosphere. If bonding is carried out in an air atmosphere, then the end face on the outer circumference comes into contact with the air, but this portion reaches full curing in the course of storage (over several days) on the manufacturing line. If irradiation is carried out in a vacuum as described above, then a merit is obtained in that the end face on the outer circumference can be cured more reliably. A similar beneficial effect can be obtained by removing (purging) oxygen with an inert gas (N₂).

The supply volume of adhesive from the adhesive supply unit, the rotation of the turntable and speed of rotation of same, the emission of light by the irradiation devices, and the operation of the heating device, the elevator mechanism and the vacuum source, and the like, are controlled by means of a control device. This control device may be realized, for example, by a dedicated electronic circuit or a computer which is operated by a prescribed program. Therefore, one mode of the present invention is a computer program for controlling the operation of the present apparatus according to the sequence described below, or a recording medium which stores such a computer program.

### Action of the Embodiment

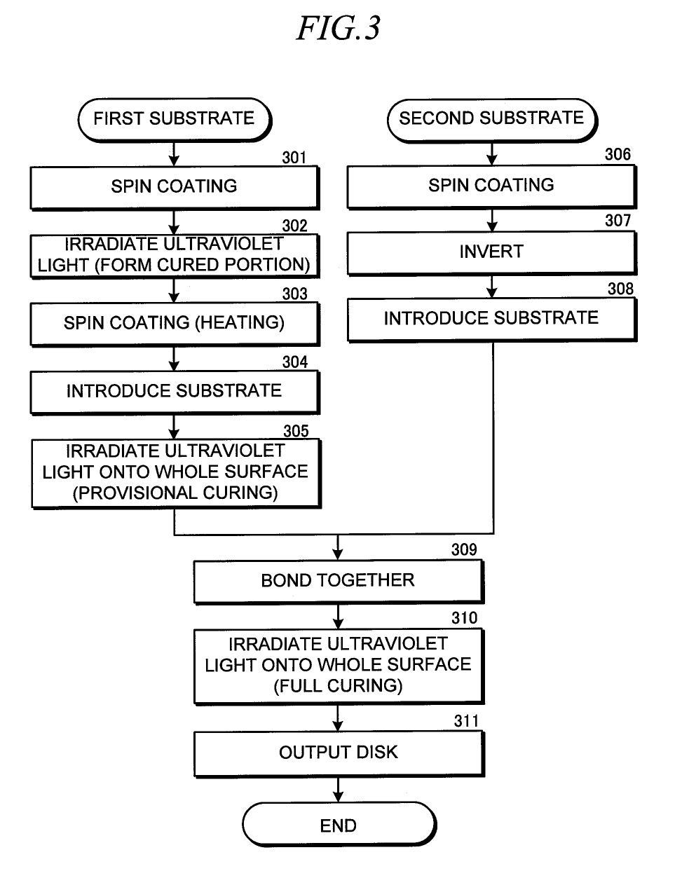

The substrate bonding procedure carried out by the present apparatus described above will now be explained with reference to FIG. 1 and FIG. 2, and the flowchart in FIG. 3. In preceding steps, a semi-transparent reflective film is formed by sputtering on one substrate P1 and a fully reflective metal film is formed by sputtering on the other substrate P2.

For the Substrate P1, in the first spin coating device 1, as shown in FIG. 1, an ultraviolet-curable adhesive is applied dripwise onto the periphery of the central hole, and the adhesive is caused to spread by rotating the turntable 11 at high speed (step 301). For example, an adhesive having a viscosity of 430 mPas is used, the application pressure is 0.2 MPa, the application time is 0.15 sec. This adhesive is distributed for 1 sec by high-speed spinning at 10,000 rpm.

Thereupon, as shown in FIG. 2, the substrate P1 is rotated in such a manner that the adhesive does not perform a flowing movement (for example, at a speed of 120 rpm to 300 rpm), and ultraviolet light is irradiated in the form of spots at the periphery of the central hole by the irradiation device 13. Consequently, a portion which is cured in a ring shape (cured portion) is formed in the adhesive that has been spread (step 302). In this case, the portion where the ultraviolet light intensity is strong is cured fully, but as the position moves toward the outer circumference, an inhibiting effect of the oxygen occurs on the adhesive, the surface of the adhesive does not solidify while the interior does solidify, and the interior is progressively cured to a lesser extent toward the outer circumference.

Next, an ultraviolet-curable adhesive is applied dripwise again on top of the adhesive of the substrate P1 on which the cured portion has been formed, and by rotating the turntable 11 at high speed, the adhesive is caused to spread (step 303). For instance, using the same adhesive as that used in the first application, the application pressure is 0.2 MPa, the application time is 0.6 sec, and the adhesive is spread for 1 sec by high-speed spinning at 4000 rpm. In this case, the adhesive is spread by applying heat locally using the heating device 14. For instance, a spot heater is used as the heat source, the wavelength is 700 to 3000 nm, the output setting is 350 W, the heating range is 40 mm to 60 mm in the radial direction of the substrate P1, and the heating time is 1 sec.

By applying the adhesive to the substrate P1 in this way, the adhesive which is warmed, thereby reducing the viscosity of the adhesive, is distributed and spread readily to the outer circumference as a result of the centrifugal force created by the rotation of the substrate. Alternatively, the adhesive receives thermal energy, and the volatilization volume is raised. Therefore, the adhesive remaining at the outer circumference becomes thinner, thus suppressing increase in the thickness of the adhesive, and therefore it is possible to achieve a uniform thickness throughout the substrate. It is also possible to apply a heated air flow to the outer circumference simultaneously, so as to supplement the heating of the adhesive.

Thereafter, as shown in FIG. 1, the substrate P1 is introduced onto the turntable 3 in such a manner that the surface of the applied adhesive B1 is facing upwards, as described above (step 304). In the pre-irradiation unit 4, ultraviolet light is irradiated onto the whole surface of the substrate in an air atmosphere by the UV irradiation device, and the adhesive B1 is provisionally cured to a degree whereby the applied form of the adhesive is not disturbed (step 305). For instance, compared to conditions used for normal full curing (50 mW/cm^{2×5}s), light is irradiated for approximately one half of the irradiation time (2s) at the same intensity.

With a general ultraviolet-curable resin (adhesive), if ultraviolet light is irradiated onto the whole surface in an air atmosphere, then full curing does not occur at a normal irradiation intensity. This is because the presence of air in the vicinity of the surface of the resin inhibits the curing process. In other words, when ultraviolet light is irradiated in an air atmosphere, it is possible to perform provisional curing while maintaining the adhesive on the surface. For example, it has been demonstrated that full curing is not carried out even under conditions of 1000 mW at 1 to 2 seconds. However, the irradiation conditions during provisional curing are not limited to those described above.

Furthermore, as shown in FIG. 1, adhesive is applied to the other substrate P2 by the second spin coating device 2 (step 306). For instance, the application pressure is 0.2 MPa, the application time is 0.6 sec, and the adhesive is distributed for 1 sec by high-speed spinning at 6,000 rpm. As described above, the adhesive B1 on the substrate P1 is made thicker and the adhesive B2 on the substrate P2 is made thinner, in accordance with the rotating conditions set for spin coating and the number of application operations. Thereupon, the substrate P2 is inverted by the inverting device (step 307), and introduced over the substrate P1 in such a manner that the application surface of the adhesive B2 is facing downwards (step 308).

Thereupon, the two substrates P1 and P2 are conveyed to the bonding unit 5, and bonding is carried out in a vacuum similarly to the prior art (step 309). The substrates P1 and P2 which have been bonded together are conveyed to the post-irradiation unit 6, and ultraviolet light is irradiated onto the whole surface in a vacuum, thereby fully curing the adhesives B1 and B2 (step 310). In this case, ultraviolet light is irradiated from the side of the substrate P1 on which the semi-transparent metal film has been sputtered. The disk D which is completed by curing of the adhesive is output from the output position 35 (step 311).

### Effects of Embodiments

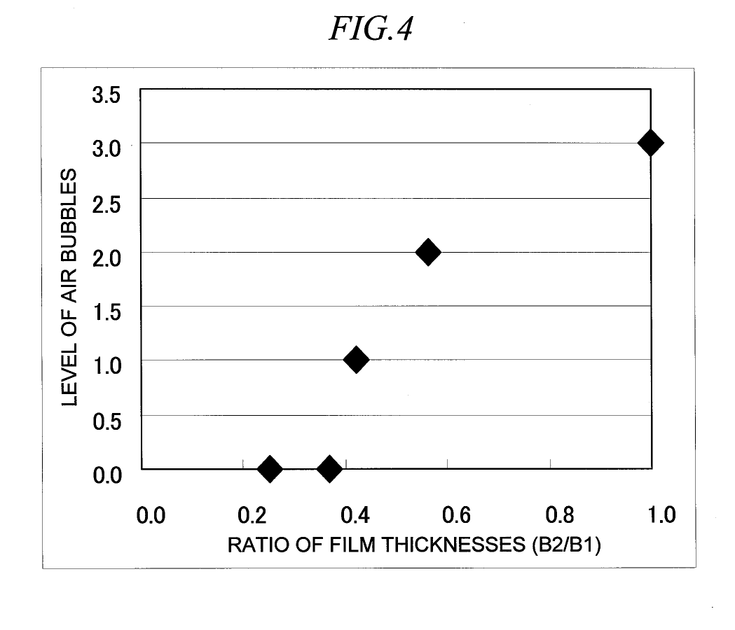

According to the present embodiment described above, by making the adhesive B1 which is applied to the substrate P1 that is to be bonded thicker than the adhesive B2 which is applied to the substrate P2, and provisionally curing the adhesive B1, then a partial region is cured in advance, and the occurrence of exhaust gases is supplied when the substrates P1 and P2 are bonded together in a vacuum, and the occurrence of residual air bubbles can be reduced. FIG. 4 shows the results of reduction of air bubbles. From this, in the embodiment described above, the level of air bubbles when the film thickness ratio (B2/B1) of the adhesives B1 and B2 was varied indicates a greater air bubble reducing effect, the greater the thickness of the adhesive B1 on the side which is provisionally cured.

This is thought to be because there is a greater amount of material which produces air bubbles in the thicker adhesive, but by carrying out provisional curing of this adhesive, a greater reduction is achieved in the amount of gas produced from inside the adhesive. The level of air bubbles was checked visually after bonding and completing full curing: level 0.0 indicates no bubbles, level 1.0 indicates the presence of some bubbles, level 2.0 indicates a moderate presence of bubbles and level 3.0 indicates a large presence of bubbles. In the prior art example, in which adhesive was applied to the same thickness on both substrates and the substrates were bonded together without provisional curing, the level was 3.0.

Furthermore, since one adhesive B1 is provisionally cured, then a beneficial effect in suppressing flowing movement is obtained, and hence in-circumference variation of the adhesive layer thickness after bonding together the substrates P1 and P2 can be suppressed. Moreover, the irradiation of ultraviolet light in order to achieve provisional curing is carried out when spin coating has finished and there is no scattering of the adhesive B1, and consequently, none of the adhesive scattered during spin coating will have started to cure. Therefore, there is no need to separate uncured adhesive from cured adhesive in the recovered adhesive, and hence the recovered adhesive can be reused without problem. Performing irradiation at a separate location to spin coating also provides similar beneficial effects. Since the spot irradiation which is carried out during rotation of the substrate P1 only involves irradiation onto a limited partial region, then there is no problem in recovering the adhesive.

Furthermore, the thickness of application can be adjusted easily by altering the application amount of the adhesive, the conditions of rotation, and the number of spreading operations. In particular, if it is wished to increase the application thickness, then a uniform thickness can be ensured by forming a cured portion and then applying adhesive in a superimposed fashion while heating, as described above, and consequently the beneficial effect in suppressing in-circumference variation can be enhanced.

### Further embodiments

The present invention is not limited to the embodiments described above. The extent of curing of the one adhesive prior to bonding is not limited to that specified above. Consequently, even if the thicker adhesive which has been applied to one substrate is fully cured rather than provisionally cured, by means of various techniques such as irradiating in a vacuum, irradiating after purging with an inert gas, increasing the irradiation intensity, increasing the irradiation time, or the like, it is still possible to obtain beneficial effects in suppressing in-circumference variation after bonding. In this case, adhesiveness during bonding is ensured by the other adhesive which has not been cured.

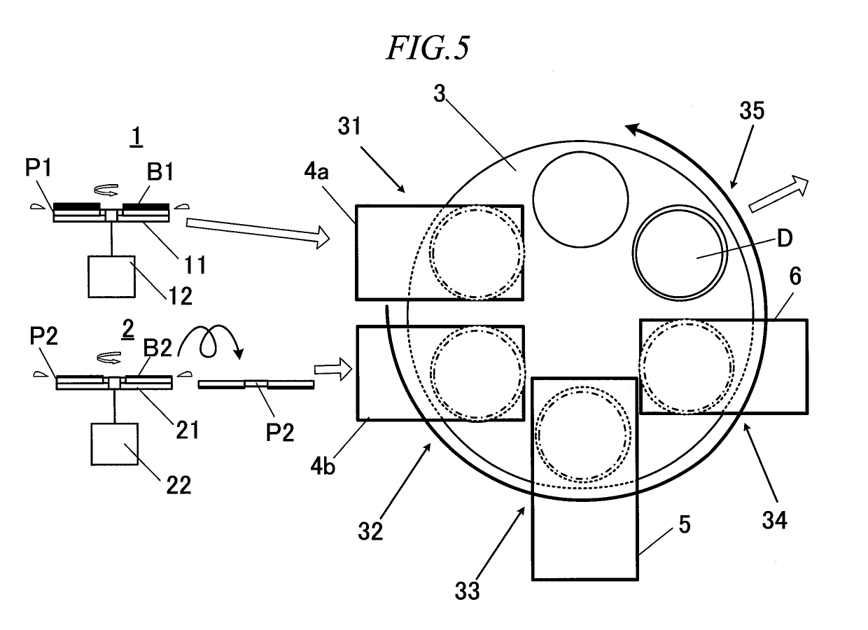

Furthermore, by providing a first pre-irradiation unit 4a which irradiates ultraviolet light onto the substrate P1 and a second pre-irradiation unit 4b which irradiates ultraviolet light onto the substrate P2, as shown in FIG. 5, it is possible to bond the substrates together after provisionally curing both of the adhesives B1 and B2. By this means, it is possible to suppress in-circumference variation yet further, as well as obtaining an effect in reducing the occurrence of air bubbles.

Adhesive which is applied thinly becomes less liable to flow, the smaller its thickness. For instance, if adhesive is applied in an extremely thin layer (of the order of several microns; a thickness whereby a cured portion is formed by spot irradiation), then flowing movement is suppressed and a beneficial effect in suppressing in-circumference variation after bonding is obtained. Accordingly, if the adhesive that is not to be cured provisionally is applied in an extremely thin layer, then an increased effect in suppressing in-circumference variation may be achieved. A beneficial effect in suppressing in-circumference variation is also obtained if this thinly applied adhesive is provisionally cured.

Furthermore, the adhesive used is not limited to an ultraviolet-curable resin, and it is also possible to use various adhesives, such as resins which are used by other sources of electromagnetic radiation (including laser light), or thermally curable resins, or the like. Consequently, various different types of electromagnetic radiation can be irradiated, such as ultraviolet light, infrared light (including heat), laser light of a prescribed wavelength, or the like, depending on the type of resin used. In the embodiment described above, in order to apply the adhesive to a large thickness, a cured portion is formed and adhesive is then applied again in a superimposed fashion, but it is also possible to achieve a large thickness by simple superimposed application, or by a single application operation in which the dropped volume of adhesive is increased. It is also possible to omit heating for spreading the adhesive. Furthermore, bonding does not necessarily have to be carried out in a vacuum.

There may be one or a plurality of application units for applying adhesive. For example, it is possible to use a common spin coating device for the first substrate and the second substrate. Superimposed application may be carried out using a plurality of spin coating devices. The application unit is not limited to a spin coating device and includes any current or future apparatus which can be used to apply an adhesive.

Furthermore, the pre-irradiation unit may be situated at any position, provided that it is after the spin coating step and before the bonding step. For example, it may be disposed in the spin coating device, or in the conveyance path from the spin coating device to the turntable. It may be provided for either one of the substrates P1 and P2 on the turntable, or for both of the substrates.

The size, shape and material, and the like, of the substrate can be chosen freely, and the present invention can be applied to any substrate which may be used in the future. Consequently, as well as being applicable to disks for recording media of any format, it may of course also be applied to write-once read-many type recording media and rewriteable recording media. Furthermore, in addition to disks for recording media, the present invention can also be applied to any substrates which are bonded together by means of adhesive. In other words, reference to “substrate” in the claims is not limited to a circular disk-shaped substrate, or the like, but rather is a broad concept which includes flat plane-shaped products.

1. A bonding method for bonding a first substrate and a second substrate by means of an adhesive which undergoes curing by irradiation of electromagnetic radiation,
the method comprising:
applying the adhesive, at respectively different thicknesses, to one surface of the first substrate and one surface of the second surface;
irradiating electromagnetic radiation onto the thicker of the adhesive applied to the first substrate and the adhesive applied to the second substrate;
bonding together the surface of the first substrate to which the adhesive has been applied and the surface of the second substrate to which the adhesive has been applied; and
irradiating electromagnetic radiation onto the adhesive between the first substrate and the second substrate.

2. A bonding method for bonding a first substrate and a second substrate by means of an adhesive which undergoes curing by irradiation of electromagnetic radiation,
the method comprising:
applying the adhesive, at respectively different thicknesses, to one surface of the first substrate and one surface of the second surface, irradiating electromagnetic radiation onto both the adhesive applied to the first substrate and the adhesive applied to the second substrate;
bonding together the surface of the first substrate to which the adhesive has been applied and the surface of the second substrate to which the adhesive has been applied; and
irradiating electromagnetic radiation onto the adhesive between the first substrate and the second substrate.

3. A bonding apparatus for bonding together a first substrate and a second substrate by means of an adhesive which undergoes curing by irradiation of electromagnetic radiation, comprising:
at least one application unit for applying the adhesive, at respectively different thicknesses, to one surface of the first substrate and one surface of the second substrate;
a pre-irradiation unit for irradiating electromagnetic radiation onto the thicker of the adhesive applied to the first substrate and the adhesive applied to the second substrate;
a bonding unit for bonding together the surface of the first substrate to which the adhesive has been applied and the surface of the second substrate to which the adhesive has been applied; and
a post-irradiation unit for irradiating electromagnetic radiation onto the adhesive between the first substrate and the second substrate.

4. A bonding apparatus for bonding together a first substrate and a second substrate by means of an adhesive which undergoes curing by irradiation of electromagnetic radiation, comprising:
at least one application unit for applying the adhesive, at respectively different thicknesses, to one surface of the first substrate and one surface of the second substrate;
a pre-irradiation unit for irradiating electromagnetic radiation onto both the adhesive applied to the first substrate and the adhesive applied to the second substrate;
a bonding unit for bonding together the surface of the first substrate to which the adhesive has been applied and the surface of the second substrate to which the adhesive has been applied; and
a post-irradiation unit for irradiating electromagnetic radiation onto the adhesive between the first substrate and the second substrate.

5. The bonding apparatus according to claim 3, characterized in that the application unit has at least one spin coating device for spreading the adhesive by causing the first substrate and the second substrate to rotate,
the bonding apparatus further comprising control means for controlling the spin coating device such that conditions of rotation are respectively different for the first substrate and the second substrate.

6. The bonding apparatus according to claim 3, characterized in that the application unit comprises at least one spin coating device for spreading the adhesive by rotating the first substrate and the second substrate,
the bonding apparatus further comprising control means for controlling the spin coating device such that the number of spreading operations is respectively different for the first substrate and the second substrate.

7. The bonding apparatus according to claim 4, characterized in that the application unit has at least one spin coating device for spreading the adhesive by causing the first substrate and the second substrate to rotate,
the bonding apparatus further comprising control means for controlling the spin coating device such that conditions of rotation are respectively different for the first substrate and the second substrate.

8. The bonding apparatus according to claim 4, characterized in that the application unit comprises at least one spin coating device for spreading the adhesive by rotating the first substrate and the second substrate,
the bonding apparatus further comprising control means for controlling the spin coating device such that the number of spreading operations is respectively different for the first substrate and the second substrate.
